(19) United States
(12) Patent Application Publication
(10) Pub. No.: US 2004/0143397 A1
(43) Pub. Date: Jul. 22, 2004

(54) Acoustic monitoring of a structure

(76) Inventors: Peter O. Paulson, Calgary Alberta (CA); John McIntyre, Calgary Alberta (CA)

Correspondence Address: BLAKE, CASSELS & GRAYDON, LLP, 45 O'CONNOR ST., 20TH FLOOR, OTTAWA, ON, K1P 1A4, CA

(21) Appl. No.: 10/478,051

(22) PCT Filed: May 17, 2002
(86) PCT No.: PCT/CA02/00721

(30) Foreign Application Priority Data
May 23, 2001 (CA) 2,348,329

(51) Int. Cl. G01V 1/00

(52) U.S. Cl. 702/14

(57) ABSTRACT

Discloses a method for monitoring acoustic wave propagation in a structure using a limited number of acoustic sensors. The transfer function of the structure is measured between each sensor and selected locations remote from the sensor using a known source of acoustic waves, such as a Schmidt hammer. Signals from the acoustic sensors are captured when a trigger event is detected; the signals received at the sensors are either compensated by the measured transfer function to estimate the nature of the signal at source, or are compared to characteristics of a compensated reference signal.

### FIELD OF THE INVENTION

The present invention provides an apparatus and method to perform acoustic monitoring of structures having tensioned wire cable structural elements, such as a suspension bridge, incorporating very few sensors.

### BACKGROUND OF THE INVENTION

A wire cable is a cable formed from hundreds, thousands or tens of thousands of individual wire strands that form a flexible elongate material resistant to tension forces. Because of the high repetition of individual wire strands provided in a wire cable, failure of an individual wire is not significant or noticeable to the overall characteristics or capabilities of the wire cable. However, where significant numbers of the wires fail, the characteristics and capabilities of the wire cable become compromised and the wire cable itself can fail under tension. Many structures include structural elements formed from wire cable subjected to or placed into tension. Tensioned wire cable is used as a structural element in varied constructions, for example, suspension bridges and concrete structures, such as buildings and pipelines. Failure of the tensioned wire cable can and frequently does result in failure of the construction that relies on the wire cable for structural integrity.

There is a need to inspect and monitor constructions or structures that contain tensioned wire cable to avoid or warn of conditions where the wire cable may or is about to fail. When an individual wire strand of the wire cable breaks, the breakage event emits or produces a mechanical manifestation, including acoustic emissions. The breakage event sends acoustic and pressure waves propagating in both directions along the wire cable. These will hereinafter be called acoustic waves and the sensors for them will be called acoustic sensors, it being understood that the waves pass through the cable and that the sensors can either pick up sound or wave mechanics.

In one conventional arrangement to monitor tensioned wire strand cable for breakage events, a microphone is placed in close proximity to the wire strand cable. The microphone captures the acoustic waves and produces representative electrical signalling. In another arrangement, a piezoelectric transducer is located on the wire strand cable or on a cable band surrounding the wire strand cable to detect vibrations in the cable. Frequently multiple transducers are positioned at predetermined locations throughout the structure that is being monitored to obtain data from multiple points. Where multiple transducers are located at predetermined locations in the structure being monitored, the location of the break can be determined using various methods.

To monitor suspension bridges, a practice heretofore is to locate a sensor at or near the location of the wire breakage. Since the location where a wire breakage will occur is largely indeterminate, monitoring the wire cables of a structure generally requires the placement of multiple sensors, so that the location of a strand breakage relative to the sensors can be determined accurately.

One prior art method of determination of the location of a wire break is effected by measuring the difference in the length of time that is taken for the manifestation of the breakage to reach each of multiple sensors. For example, if sensors are located on either side of a breakage, the time of arrival of the breakage manifestation at each sensor can be used to calculate the location of the breakage, as described in more detail in my published patent application WO98157166.

In another prior art wire cable monitoring system, sensor information is processed locally to determine what sensor data should be retained or discarded. A system of this type is disclosed in U.S. Pat. No. 4,609,994 to Bassim et al. In the monitoring arrangement of Bassim, each sensor is provided with apparatus to processes the sensor data to determine what data should be retained or discarded.

In another prior art wire strand cable monitoring system disclosed in U.S. Pat. 5,987,990 to Worthington, sensor information is processed locally and includes a time stamp associated with the sensor data that is retained. In accordance with the teachings of Worthington, the time stamp is obtained from the global positioning system (GPS) satellite constellation provided by the U.S. military.

Providing local processing of sensor data at the sensor requires additional apparatus at the sensor, which must be powered to operate. Real time acoustic information can produce a digital data stream that has in the order of hundreds of thousands or millions of bits per second. Consequently, significant storage must be provide at each sensor if all data is recorded. To reduce the data storage requirement, each sensor may include processes to assess the data to determine what is significant data which is to be retained and discard all data not meeting the assessment criteria.

Instrumenting large structures with sensors can create some severe problems in installation and operation, including the following:

sensors require wires for communication and power supply which incurs cost and complicates the installation and maintenance on large structures such as bridges.

sensors that make local decisions about what information to keep or not to keep require more electronics and more power to operate.

sensors that make local decisions about what information to keep or not, may not keep information that might be useful when considered in conjunction with information that is available to other sensors instrumented on the same structure, thereby losing potentially valuable information.

### SUMMARY OF THE INVENTION

I have observed that if very sensitive sensors, such as those that have a sensitive piezoceramic element with a large Q, that is the amount of charge generated per G of acceleration, are used and amplification of the sensor output signal is effected close to the sensor, then very sensitive sensors with large signal gains can be obtained. Preferably, the sensor is mounted to obtain particular sensitivity to acoustic waves moving axially along the wire strand cable, such as by placing it's Z axis parallel to the cable axis. With such a sensor configuration and placement, the signals expected from events that generate large axial signals, such as a tensioned wire strand break, can be detected over distances of thousands of feet.

The invention provides an arrangement to reduce sensor signal noise and process sensor data to provide useful monitoring output for large structures containing tensioned wire strand cable such as suspension bridges from very few sensors. For example, in one embodiment of the invention, a suspension bridge can be monitored using the principles of the invention with two sensors on each catenary, or main support, cable.

The method and apparatus of the invention simplifies the sensor electronics, consequently reduces the cost of each sensor and reduces the power consumption of each sensor. The system provides centralized processing of data from all sensors and, consequently, centralized acquisition and assessment of the significance of any event based on data received from a plurality of sensors.

In one configuration adapted for use with suspension bridges, a sensor is mounted proximal to the end of each wire strand cable, with optional additional sensors at the towers or elsewhere. Event location can be determined from the arrival times of the waves produced by the event at each respective sensor. The sensor signals are processed in an acquisition system to allow the rejection of noise sources that do not have the desired characteristics, for example, of a wire strand break. The signal processing includes an examination of the arrival times of the signal at the respective sensor and an examination of the associated energies and other characteristics of the signal. The signal processing examination is performed by an acquisition computer, which forms an assessment of the significance of a signal from an examination of the signals produced by each sensor, for example, to determine whether or not the source of the event was a wire strand break.

To monitor suspension bridges, it is preferred that there be a sensor at or near each termination end of the wire strand cable being monitored. The location of a wire strand breakage relative to the sensors can be determined accurately based on time of arrival of the breakage manifestation at the sensor. Additional sensors may be placed on the cable if desired. For example, to monitor the catenary suspension cable of a suspension bridge, a sensor may be place on the node or point where the cable passes over a vertical support, for example a support tower. The breakage manifestation will propagate through the node. Thus, where monitoring a cable that continues through a node, it is not necessary to have a sensor at that node. However, it is preferred to have a sensor at each node, as sensors so placed can acquire useful information about cable slippage and further information relating to the nature of the event causing the signal to be produced by the sensor.

For example, a signal arriving at both ends of the catenary cable of a suspension bridge at about the same time must have originated near the centre of the bridge. If the signal originated from the centre of the bridge, and if the rate of signal attenuation in that cable is known, then an estimate of the energy of the event at the source is possible. Further, if the different attenuation rates of different frequencies over each portion of the wire strand cable length are known, then the spectral profile of the event at the source may be reconstructed from the signals received from the sensors. The reconstructed event at the source may then be compared with known reference events to establish the likelihood that the received signalling is representative of a reference event or an event of interest, such as a wire strand break

Only signals that have the required energy or amplitude profile consistent with their distance from the source, and that further have the spectral characteristics expected at that distance, would then be categorized as a wire strand break. Events categorized as a wire strand break are selected for further consideration, for example by storing the data received from all sensors or certain sensors, activating an alarm, transmitting the data elsewhere and by displaying the data.

The arrangement of the invention includes multiple high-sensitivity sensors, knowledge of the attenuation characteristics of the structure, knowledge of the characteristics of the type of events of interest, and a method of processing sensor signalling to discriminate and select signalling that is representative of an event of interest. The principles of the invention can be applied to acoustic monitoring of structures such as suspension bridges or the tensioned wire supports of a building with sensors located sparsely around the structure that is the bridge or the building.

In addition to a profile of frequency attenuation data, other characterizing profiles can be developed for the structure to be monitored. For example, a velocity profile of the structure and a profile of the rate of dispersion of frequencies of the structure that are characteristics can be developed. Therefore, improved accuracy of estimation or reconstruction of the source of the event and its location can be obtained.

It is preferable to communicate sensor signalling to the signal acquisition processor by a wireless radio frequency (RF) link. Wireless radio frequency (RF) transmission is restricted by government regulations, which limit the number of available communications channels. However, the fact that wireless transmitters are able to transmit the sensor data continuously makes them attractive, provided the wireless transmission does not introduce unwanted artifacts to the data transmitted. Radio communications over the link can be accomplished using either a continuous analogue transmission or, alternately, digital transmission can be used.

Analogue transmission is advantageous because the uncertainty in signal arrival times at a receiver are very small, typically less than 10 microseconds for line of sight transmission. Digital systems have the advantage of more communications channels by virtue of digital communication techniques. Digital systems provide capabilities for very large bandwidth and dynamic range. However, to effect digital communication requires buffering the data to be transmitted over a wireless channel, which can cause unpredictable transmission delays.

Sending data from the sensors to a central point using either analogue or digital wireless must provide a reliable time base. A reliable time base is required to permit coordinating or comparing the arrival times of the signals at each sensor in order to calculate the position of a source of acoustic energy propagating through the structure. Radio communications is acceptable provided there is a known or predictable small delay in the transmission process. In the digital form, this means that the time involved in doing digital buffering must be known to within 5 milliseconds. The 5 milliseconds uncertainty would allow estimation of the location of a source to within about 10-20 meters, depending on the wave propagation velocity. The timing is said to be deterministic if the delay period is controlled or known. Therefore, a deterministic digital RF stream can be used in continuous transmission mode to relay sensor signalling of acoustic information to a central point. Because there is a common or deterministic time base, the information received at the central point can be analyzed to determine the nature and location of the source of the event as previously described.

It is preferable that that the continuous data transmission be sustained by local power gleaning methods, such as solar panels.

In the measurement and monitoring of wire strand cable events, I have found that the sensors must allow bandwidth of at least 10 kHz and a dynamic range of at least 60 dB to be useful. I have also found it is preferable to have three sensors placed on each of the tensioned catenary wire strand cables of a large suspension bridge structure. The third sensor is useful in introducing redundancy to facilitate in place measurement of profile characteristics, such as event wave propagation velocity.

With the principles of the invention, a suspension bridge could be monitored with no cabling. The locally powered wireless sensors address some severe problems in instrumenting large structures. The locally powered wireless sensor and central acquisition configuration of the invention permits:

Instrumentation of large structures such as suspension bridges without wires and the associated cost and cost and complications of wire installation and maintenance on such large structures.

less electronics and less power requirements to produce and operate the wireless sensor detector system.

Improved event data retain or discard decision making based on information from multiple sensors.

In one of its aspects, the invention provides a method of monitoring acoustic wave propagation in a structure by coupling at least two acoustic sensors to a structure at a first sensor location and a second sensor location, remote from the first sensor location. The signals from each acoustic sensor are monitored at an acquisition system for a trigger event When a trigger event is detected, the location of an acoustic source corresponding to the trigger event is calculated. The signal from each acoustic sensor is transformed using the calculated location. Selected parameters of the transformed signal are tested against corresponding parameters of an event of interest. The signals from each acoustic sensor are logged for each event of interest.

In another of its aspects, the invention provides a method of monitoring acoustic wave propagation in a structure comprising coupling an acoustic sensor to a structure at a first sensor location and at least one other acoustic sensor coupled to the structure at another sensor location remote from said first sensor location. Determining at least one acoustic wave transfer function of the structure between said first and other sensor locations and an acoustic wave transfer function of the structure between each said first and second sensor locations and at least one location in the structure remote from each said first and second sensor locations. Monitoring signals from each acoustic sensor at an acquisition system for a trigger event. Upon detection of a trigger event, calculating the location of an acoustic source corresponding to the trigger event and transforming the signal from each at least one acoustic sensor using the wave transfer function of the structure based on the calculated location of the acoustic source. Then testing selected parameters of the transformed signal against corresponding parameters of an event of interest; and logging the signals from at least two acoustic sensors for each event of interest.

In yet another of its aspects, the invention provides a method of monitoring acoustic wave propagation in a structure comprising coupling at least two acoustic sensors to a structure at a first sensor location and a second sensor location remote from said first sensor location. An acquisition system monitors the signals from each acoustic sensor for a triggering event and upon detection of a triggering event, the location of an acoustic source corresponding to the trigger event is calculated. The parameters of an event of interest are transformed using the calculated location of the acoustic source. Selected parameters of the monitored signal are tested against the corresponding transformed parameters of an event of interest. For each event of interest, the signals from each acoustic sensor are logged.

The invention will now be described with reference to the attached drawings in which like reference numbers have been used to designate like features of the invention throughout the various figures of the drawings.

### BRIEF DESCRIPTION OF THE DRAWINGS

FIG. 1 is an elevation view of a suspension bridge configured with sensor apparatus in accordance with the principles of the invention.

FIG. 2 is an elevation view of a suspension bridge catenary cable anchorage configured with sensor apparatus in accordance with the principles of the invention.

FIG. 3 is a cross section view of a suspension bridge catenary cable configured with sensor apparatus.

FIG. 4 is an elevation view a suspension bridge catenary cable configured with sensor apparatus.

FIG. 5 is an enlarged cross section view of FIG. 3.

FIG. 6 is a schematic diagram of a sensor radio communications system.

FIG. 7 is a data flow diagram of a sensor acquisition system

FIG. 8 is a schematic diagram of an acquisition trigger apparatus.

FIG. 9 is a block diagram of a transfer function transformation.

FIG. 10 is an elevation view of a structure characterizing measurement arrangement.

FIG. 11 is a flow chart of a process to evaluate sensor data to determine events of interest.

### DETAILED DESCRIPTION OF THE PREFERRED EMBODIMENTS

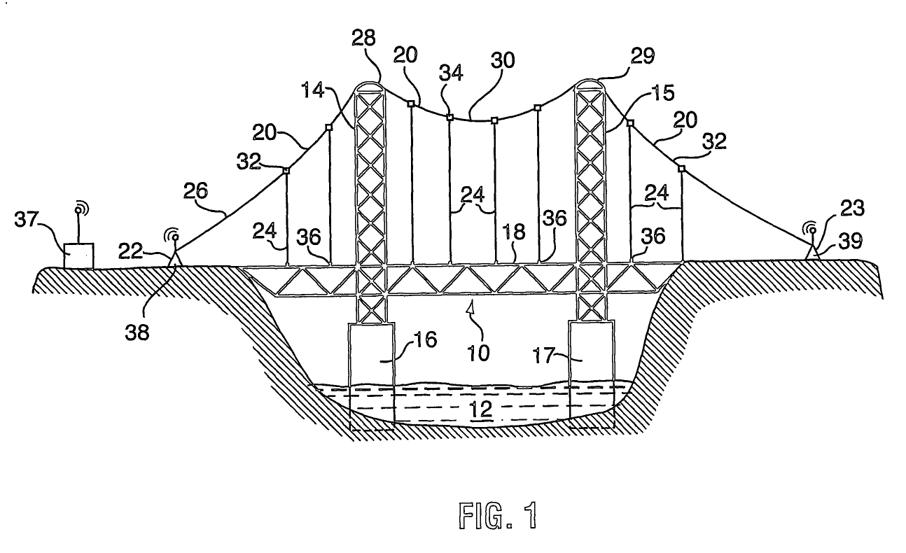

Reference is made to FIG. 1 of the drawings which shows an elevation view of a suspension bridge, generally depicted by reference number 10. The bridge 10 extends over water, indicated as 12 and has two vertical pylons 14 and 15 resting on piles 16 and 17 supporting a roadway 18.

The roadway 18 is suspended from two catenary suspension cables 20, which are supported by the two pylons 14 and 15. Only one of the two suspension cables is visible in the figure, the second cable lies directly behind the one depicted. Each end of a suspension cable 20 is attached to the ground by a cable anchorage 22, 23.

The suspension cable 20 has a first portion 26, which runs between a cable anchorage 22 and a mount 28 disposed at the top of pylon 14. A second portion 30 is suspended between mount 28 on pylon 14 and mount 29 on the top of pylon 15. A third portion 34 descends from mount 29 to cable anchorage 23.

Extending between suspension cable 20 and roadway 18 are a plurality of suspender ropes 24 positioned at intervals along suspension cable 20. Each suspender rope 24 is attached to the suspension cable 20 by a respective band 34. The other end of each suspender rope is attached to a hanger 36 to support the roadway 20. In the description that follows, the term node or nodes refers to any of the cable anchors 22, 23, the mounts 28, 29, the bands 34 or the hangers 36.

According to the invention, sensors 38, 39 are placed at cable anchors 22, 23.

An acquisition system generally depicted at reference numeral 37 receives the signals produced by the sensor.

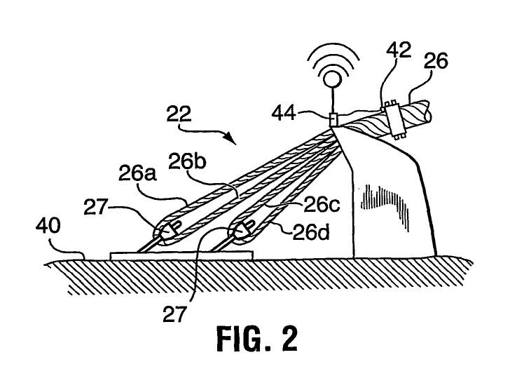

FIG. 2 shows an elevation view of a representative anchor 22. At anchor 22, cable 26 is splayed into groups of wires 26a, 26b, 26c and 26d, each of which is secured to anchor means, for example, a footing 27 immobilized in the earth. Although only four such wire groups are shown, a typical cable is splayed into many more than four. The splayed end of the cable terminates in the anchor means. The anchor means are usually protected against corrosion by being potted into potting metal or otherwise immobilized and protected from moisture and may be housed in an enclosure structure, such as a building (not shown).

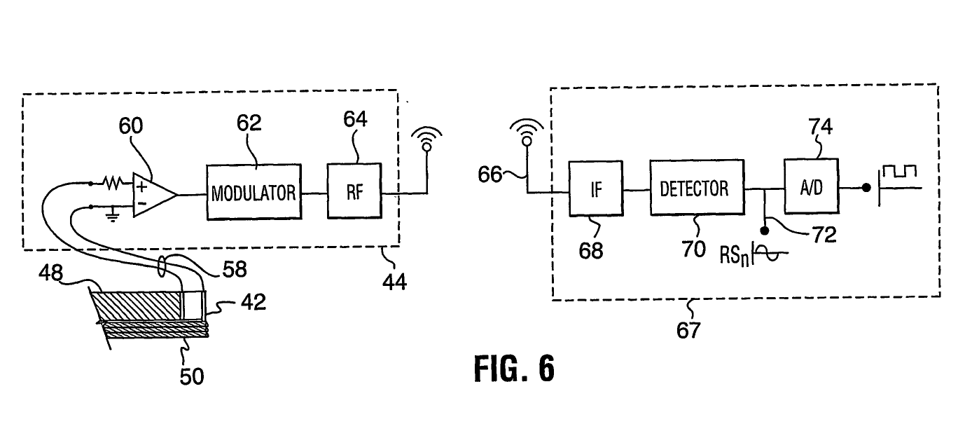

Placed at a convenient location near the end of cable 26 is sensor 42. Sensor 42 is attached to the cable in any suitable way such as by gluing with a suitable adhesive or attaching it with a small clamp. Where the cable or cable band has been painted or wrapped with a protective material, it is preferable to remove the paint or wrapping to provide direct contact between the cable or cable band and the sensor. Sensor 42 converts the acoustic signals that it receives to electrical signals, which are amplified and transmitted by transmitter 44. FIG. 6 shows a more detailed schematic diagram of the sensor and radio transmitter apparatus.

Generally depicted by reference numeral 20 of FIG. 3 is a cross-section of a main or catenary cable of a suspension bridge. A cable band 34 surrounds the plurality of wire strand cables 50 that are bundled together to form the main suspension cable 20. A nut and bolt pair retains the sections of the cable band 34 around the wire strand cables. Each bolt passes through bolt sleeves 52 and a mating nut is affixed and tightened to the bolt. To permit personnel to walk on the cable band for maintenance and inspection purposes, the main cable generally includes a handrail supported by stanchions 54 disposed on either side of the main cable. A transmitter 44 is shown attached to one of these stanchions, which serves to support transmitter 44 proximal to a sensor 42. A solar panel 56 is provided as a source of energy for transmitter 44.

FIG. 4 shows a side elevation of the arrangement of FIG. 3. Sensor line 58 interconnects the sensor 42 to the transmitter 44.

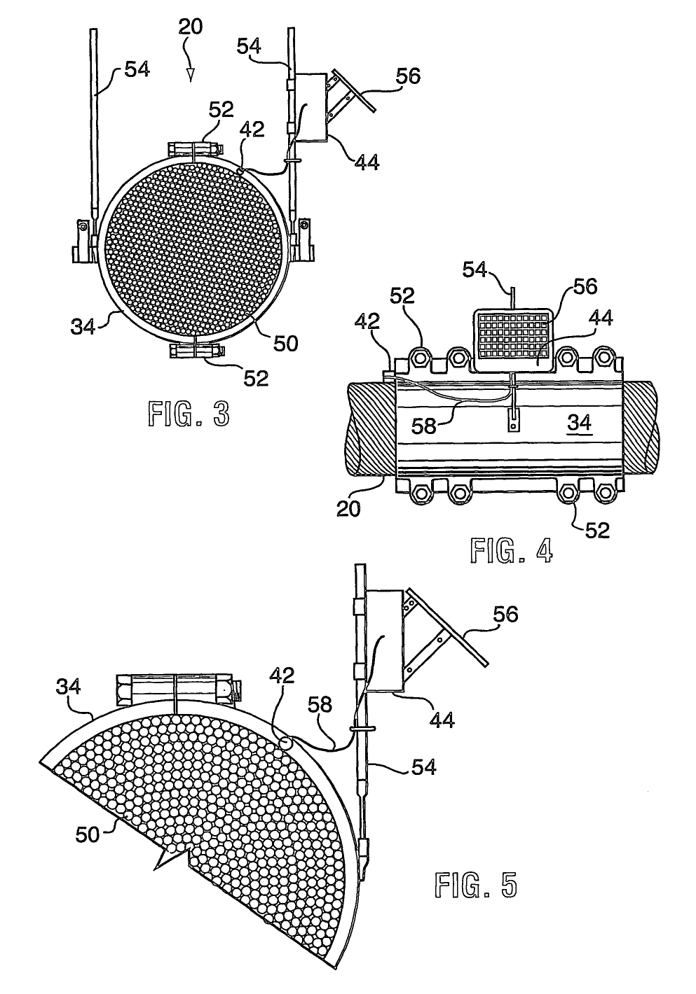

FIG. 5 is an enlarged partial cross-section of the apparatus of FIG. 3 showing the location of sensor 42 on an edge of cable band 34. The orientation of the sensor 42 provided by placement on an edge of cable band 34 is one manner of alignment of a sensitive or high Q axis of sensor 42 to the axis of main suspension cable 20 to orient the sensor to P-wave propagation in the main cable 20.

FIG. 6 is a schematic diagram of a sensor 42 and its associated transmitter 44 and receiver 67 that provide a wireless communications channel over which o communicate the sensor. The output from transducer 42 is provided to an amplifier 60, the output of which is provided to a modulator 62 which modulates the signal for transmission by a radio frequency transmitter 64. The transmitted signal is received at the antenna 66 of a corresponding receiver 67. The received signal is amplified and conditioned for recovery of a signal corresponding to the original sensor signal. For example, a demodulator circuit comprising an intermediate frequency receiver amplifier 68 provides an output to a detector 70. The output of detector 70 is produced as an analogue signal on line 72, which is represented by the waveform graph RSn in the Figure. For further processing and analysis, the received sensor signal is preferably converted to digital form. Preferably, an analogue to digital (A/D) converter 74 is provided to facilitate digital signal processing of the received sensor signal to occur. The analogue to digital conversion includes 50,000 to 100,000 samples per second at a resolution based on a suitable number of bits, for example 12 bits, to provide a faithful capture of the signal frequencies of interest, namely, signals in the 5 to 15 kHz range.

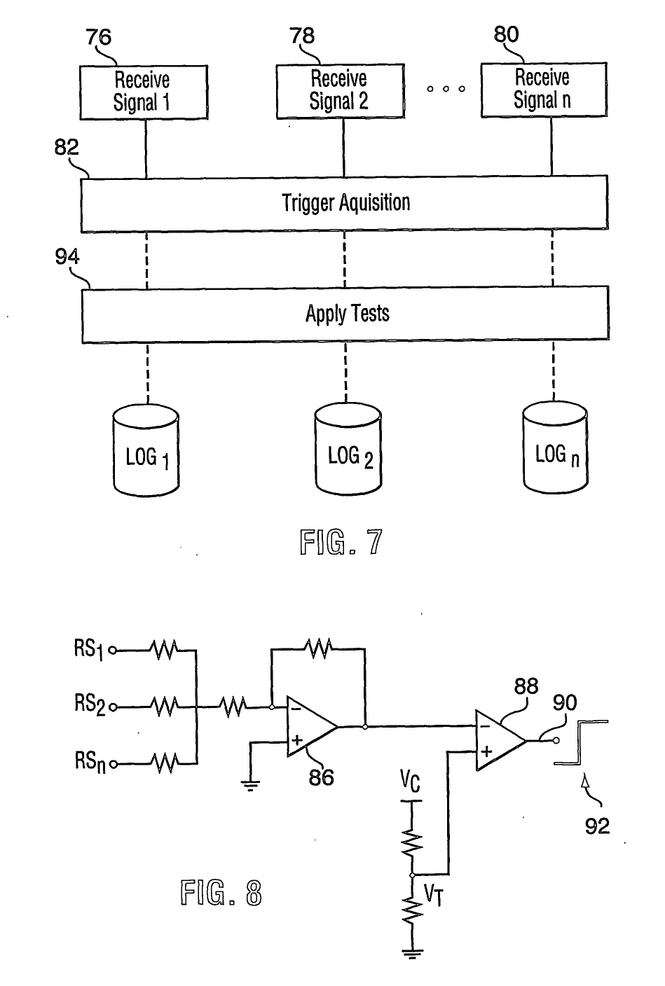

FIG. 7 is a data flow diagram depicting a signal processing flow for each received sensor signal. Each received sensor signal is supplied to the acquisition system as represented by the three process blocks 76, 78 and 80. The Received Signal 1 process block 76 relates to the received sensor signal from a first sensor, the Received Signal 2 process block 78 relates to the received sensor signal from a second sensor and the Received Signal n process block 80 relates to the received sensor signal from an nth sensor. Either the analogue form or the digital form of the received sensor signals may be processed by the trigger acquisition test 82 depending on whether the analogue or digital output of the sensor is used.

FIG. 8 is a schematic diagram showing a trigger acquisition system 82 implemented in an analogue signal processing form. The arrangement of FIG. 8 produces a trigger signal 92 from the analogue form of the received sensor signals that are provided by the respective receivers on lines 76, 78 and 80. The received sensor signals RS₁, RS₂, and RSₙ are summed by an op amp 86. The output of op amp 86 is supplied to a comparator 88, which produces a binary trigger signal on line 90 when any one of the input signals RS₁, RS₂, . . . and RSₙ exceeds a predetermined amount. In this manner, the amplitude of the received signals RS₁, RS₂, . . . and RSₙ is compared to a threshold amplitude amount V_{T} supplied to comparator 88. When any one of the received signals RS₁, RS₂, . . . and RSₙ has an amplitude that exceeds the threshold amount V_{T}, a trigger event is signalled by an output level transition on line 90 depicted by the step function waveform 92.

It will be understood that each of the received signals RS₁, RS₂, . . . and RSₙ can be converted to a digital representation and the foregoing description of the amplitude comparison of the received signals to a threshold amount can be conducted in the digital domain using a computer device.

As depicted by process block 94 of FIG. 7, when a trigger event is detected, tests are applied against parameters that characterize the received signals RS₁, RS₂. . . and RSₙ. There are several parameters of the received signals that can be tested to determine if the signals have characteristics that are either consistent with or representative of an event of interest. One of the parameters of a received signal that can be tested is its spectral content. The characteristics of the spectral content of a received sensor signal will provide an indication as to whether the received sensor signal is consistent with an event of interest. For example, a wire break will contain significant portions of its energy within a frequency range of 5 to 15 kHz.

The received sensor signal amplitude is another parameter of a received signal that can be tested for consistency with an event of interest. The amplitude of a received signal will be representative of the energy dissipation of the event that produced the signal. The amplitude characteristics will indicate whether or not the signal represents an event large enough to warrant further consideration. For example, whether the signals represent energy dissipation above or within a range of the desired energy dissipation. The energy dissipation of a wire break is generally in the range of 1 joule. Therefore, a received signal amplitude corresponding to a range of energy content of 0.1 joules to 10 joules can be selected as a range of signals warranting further analysis. When a high-energy dissipation event occurs, such as a vehicle crashing into the bridge, then the energy content will be above the range of the event of interest, which is a wire break. While a wire break may have occurred as a consequence of a collision, the fact that a high-energy signal has been received will, in any event, mask the event of interest.

Another parameter that can be tested is the duration of the received signal. The duration of a signal will characterize an event and provide an indication whether the event is one of interest. A wire break event has a duration of a few milliseconds. On the other hand, a received signal which has a duration of beyond that, for example, of seconds or several seconds is not consistent with production by a wire break.

Structure Transfer Function

The parameters of a received signal will vary depending on the location on the structure of the event producing the acoustic waves relative to the location on the structure of the sensor producing the signal in response to acoustic waves at the sensor. That is, the acoustic waves produced by an event will be transformed by their passage through the structure. When an acoustic wave propagates through a structure, the parameters of the wave will change. The wave amplitude will change, there will be a delay in the time of arrival of the wave at the sensor relative to the time when the event that produced the acoustic wave occurred and other effects will occur. The wave propagation in the structure will change the wave parameters and consequently, will change the parameters of the detected signal produced by a sensor to be different from the original.

To provide a better estimate of the acoustic waves produced by an event occurring remotely from a sensor, the transfer function of the structure, that is characteristics of transformation of a wave in its propagation through the structure is preferably measured.

A transformation of an input signal Ψᵢ to an output signal Ψₒ by a transfer function ƒ can be denoted as Ψₒ=ƒ(Ψᵢ). In the case of signalling produced by a sensor of an acoustic event, the parameters of the signalling output by a sensor will vary depending sensor's location on the structure relative to the location on the structure of the event producing the acoustic wave. For wave propagation along a cable, the distance between the fixed location of a sensor and the location of an acoustic event will determine the form of the transformation of the signal.

FIG. 9 depicts exemplary of transfer functions relating to two parameters of an acoustic wave, namely amplitude and velocity. The amplitude of the frequency components of an acoustic wave will attenuate as it propagates through a structure. Amplitude attenuation is represented in the upper portion of FIG. 9, which indicates that a signal produced by a sensor located at a source of an acoustic event Ψᵢ will be transformed as a function of frequency and distance, represented by the transform box containing the notation ƒ_{A}(f, l), into a signal produced by a remotely located sensorΨ_{AO}. Also, the velocity of the frequency components of an acoustic wave will vary as it propagates through a structure. This velocity variation is represented in the lower portion of FIG. 9, which indicates that a signal produced by a sensor located at a source of an acoustic event Ψᵢ will be transformed as a function of frequency and distance, represented by the transform box containing the notation ƒ_{V}(f, l), into the signal produced by a remotely located sensor Ψ_{VO} .

The transfer function of a structure acting on acoustic waves passing through it can be characterized using the apparatus and method of FIG. 10. A known acoustic event source is used thus reducing the sensor requirement to one sensor, which is placed in the desired location. As shown in FIG. 10, a structure 100, for example the catenary cable, has a sensor 102 placed at a selected location. An acoustic event manifesting device 104, for example, a Schmidt hammer, is placed at a selected distance from the sensor 102 to produce acoustic waves having known parameters. The Schmidt hammer is operated to manifest an acoustic wave of known parameters, represented by function Ψᵢ, within structure 100. The acoustic wave produced by the Schmidt hammer will propagate along structure 100 over the distance “l” to arrive at sensor 102. The characteristics of the acoustic wave function Ψₒ produced by the sensor 102 will measure the transfer function ƒ(f,l) of the structure 100. In this manner, the transfer function characteristics of the structure 100 can be determined. The transfer function characteristics are measurable at the distance “I” between the location where the event was triggered by hammer 104 and the signalling representative of that event produced by sensor 102.

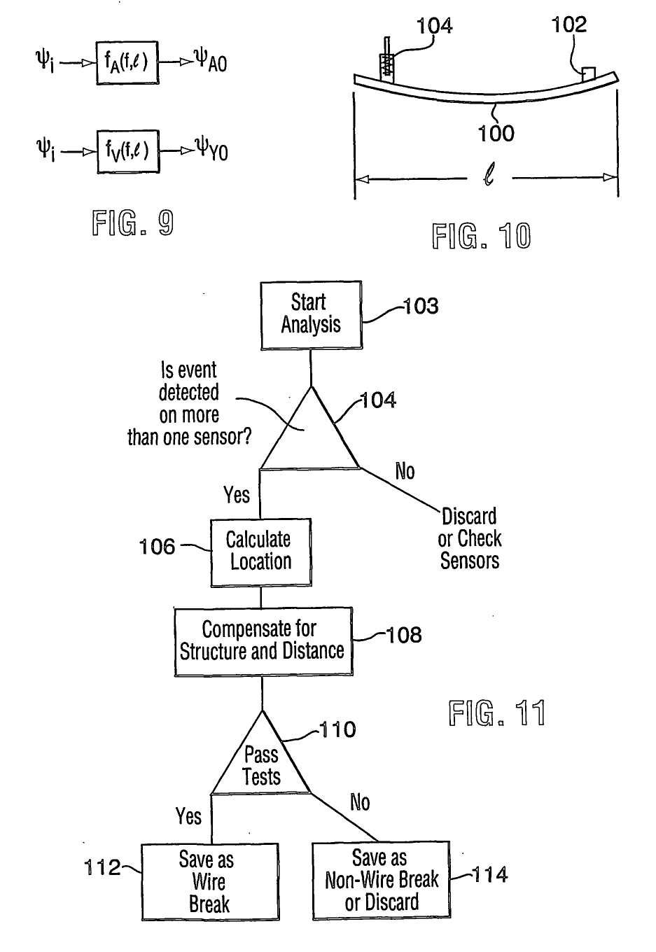

FIG. 11 shows a process flow chart implementing the test analysis system 94 of FIG. 7. The test analysis process of FIG. 11 commences at the Start Analysis block 103 when the trigger acquisition event 82 occurs. The test analysis is applied to process the signals produced by the receivers and appearing on lines 76, 78 and 80 in FIG. 7. The process flow chart details the process carried out corresponding to the Apply Tests process box 92 of FIG. 7. The test analysis is employed to analyze the received sensor signals to determine whether an event which has been acquired by the acquisition system is an event of interest.

To apply the test analysis, it is necessary to process at least one of the received sensor signals. If an event is detected at only one sensor, then the “No” exit of decision box 104 is taken and the sensor signalling is discarded. On the other hand, if an event is detected at more than one sensor, then the “Yes” exit of decision box 104 is taken and the Calculate Location calculation process of box 106 is performed. The relative times of arrival of the acoustic wave manifestation of an event at each sensor is used to calculate the location of the event. The locations of the sensors are known from the placement of the sensors on the structure. Thus, the location of an event is calculated from the differences in the time of arrival of the acoustic wave at two different sensors of a known location.

Once the location of an event has been determined, the transfer function transformation characteristics of the structure, which have been determined in the manner described with reference to FIGS. 9 and 10, is applied to at least one of the received signals. The inverse of the transfer function transformation is applied to the received signals to compensate for the transformations or distortions that were introduced into the acoustic wave as it propagated through the structure. An inverse of the transfer function transformation applied to the received signal provides a mechanism to reconstruct a representation of the acoustic wave at its source. This compensation or reconstruction process is depicted in process box 108 of FIG. 11. Where there are two sensor signals, each sensor signal is processed to provide a reconstruction of the acoustic wave at source. Thus, a reconstruction result, namely a reconstruction of the acoustic wave at source, is produced from the signalling received at each sensor.

The parameters of the reconstruction of the acoustic wave at source are then tested as shown in the Pass Tests decision box 110. Selected parameters, for example, amplitude, spectral content, duration, are compared in a series of tests, to determine if the event as reconstructed is an event of interest. Decision box 110 depicts this comparison. The tests are used to determine if the parameter characteristics of the event indicate or are consistent with an event of interest, such as a wire break. For example, the event location calculation can be compared against the known features of the structure to determine if the event is located in an area where a wire break can occur, that is to say, on the main cable or on the suspender cables.

For a wire break, the energy content parameter of a wire break is typically in the range of about 0.1 to 10 joules. Thus, the amplitude of the reconstructed event will be of interest to determine if the energy content is appropriate. The energy content parameter can be evaluated over a frequency spectrum for refinement of the testing comparisons. For example, a wire break event typically provides most energy in the frequency band extending from 500 Hz to 15 kHz. The event reconstruction process provides a representation of the event that compensates for the transformations or distortions introduced by the propagation of the event acoustic wave over the length of the structure extending between the event location and the sensor.

Another parameter that can be tested is the duration of the event. The duration of the event is determined more precisely when the inverse dispersion transform or compensation is applied to the signal. Dispersion of an acoustic wave will tend to lengthen the apparent duration of an event. A wire break event has a typical duration in the range of 5 to 50 milliseconds. The reconstructed event wave will provide a better estimate of an event duration, which can be tested against criteria of interest, such as the time range of 5 to 50 milliseconds for a wire break event.

In the Pass Tests decision box 110, the characteristics of the parameters of an event are tested against one or more parameter assessment criteria, some of which have been outlined above, to determine if the event is to be saved as an event of interest. If the result of the Pass Tests process categorizes the event as one of interest, for example a wire break, then the “Yes” exit of decision box 110 is taken. When the “Yes” exit is taken, the process of process box 112 is performed and the event signalling is saved as a wire break event. When the event does not pass the tests that have been applied in the process of decision box 110, the “No” exit is taken. When the “No” exit of decision box 110 is taken, the event signalling is stored as an uncategorized event or the event signalling is discarded as represented by the process box 114.

In another implementation, once the location of an event has been calculated the transfer function transformation characteristics of the structure are applied to the test parameters that the received signals are tested against. The transfer function transformation is applied to the test parameters to compensate for the transformations or distortions that were introduced into the acoustic wave as it propagated through the structure. The transfer function transformation is applied to the received signal test parameters to provide a mechanism to relate the test parameters to a representation of the acoustic wave at its source. This compensation or reconstruction process is also depicted in process box 108 of FIG. 11. Where there is more than one sensor signal, each sensor signal is tested against the transformed test parameters, which provide a reconstruction of the test parameters as if applied to the acoustic wave at source. Thus, a reconstruction result, namely a reconstruction of the test parameters of an acoustic wave at source, is applied to the signalling received at each sensor.

It is the parameters of the reconstruction of the test parameters that are then used as shown in the Pass Tests decision box 110. The transformed or reconstructed parameters, selected ones including for example, amplitude, spectral content, duration, are compared in a series of tests, to determine if the event is an event of interest. Decision box 110 depicts this comparison. The tests are used to determine if the parameter characteristics of the event indicate or are consistent with the transformed parameter characteristics of an event of interest, such as a wire break. For example, the event location calculation can be compared against the known features of the structure to determine if the event is located in an area where a wire break can occur, that is to say, on the main cable or on the suspender cables.

For a wire break, the energy content parameter of a wire break is typically in the range of about 0.1 to 10 joules, however, the amplitude at the sensor will be correspondingly less due to the attenuation of the wave in passage through the structure. Thus, the transformed amplitude range of the reconstructed event of interest will be a correspondingly lower range due to the structure attenuation of the wave before it can be determined if the energy content is appropriate. The energy content parameter can be evaluated over a frequency spectrum for refinement of the testing comparisons. For example, a wire break event typically provides most energy in the frequency band extending from 500 Hz to 15 kHz. The event reconstruction process will provide a representation of the event that compensates for the transformations or distortions introduced by the propagation of the event acoustic wave over the length of the structure extending between the event location and the sensor.

Another parameter that can be tested is the duration of the event. The duration of the event is determined more precisely when the structure dispersion transform or compensation is applied to the test range applied to the sensor signal. Dispersion of an acoustic wave will tend to lengthen the apparent duration of an event. A wire break event has a typical duration in the range of 5 to 50 milliseconds. The test duration range as reconstructed from the location of the event wave will provide an estimate of an event duration including adjustment for wave dispersion in the structure.

In the Pass Tests decision box 110, the characteristics of the parameters of an event are tested against one or more adjusted parameter assessment criteria to determine if the event is to be saved as an event of interest. If the result of the Pass Tests process categorizes the event as one of interest, for example a wire break, then the “Yes” exit of decision box 110 is taken. When the “Yes” exit is taken, the process of process box 112 is performed and the event signalling is saved as a wire break event. When the event does not pass the tests that have been applied in the process of decision box 110, the “No” exit is taken. When the “No” exit of decision box 110 is taken, the event signalling is stored as an uncategorized event or the event signalling is discarded as represented by the process box 114.

Now that the invention has been described with reference to the preferred embodiments, numerous variations, substitutions and equivalents will occur those skilled in the art but the scope of the invention is defined in the claims appended hereto.

I claim:

1. A method of monitoring acoustic wave propagation in a structure comprising:
(i) coupling at least two acoustic sensors to a structure at a first sensor location and a second sensor location remote from said first sensor location respectively;
(ii) monitoring signals from at least one acoustic sensor at an acquisition system for a trigger event;
(iii) upon detection of a trigger event, calculating the location of an acoustic source corresponding to the trigger event;
(iv) transforming the signal from each acoustic sensor using the calculated location;
(v) testing selected parameters of the transformed signal against corresponding parameters of an event of interest; and
(vi) logging the signals from each acoustic sensor for each event of interest.

2. The method of claim 1 wherein the detection of a trigger event occurs when the amplitude of a signal from an acoustic sensor exceeds a threshold value.

3. The method of claim 1 wherein the selected parameters include the amplitude, spectral content or duration of the transformed signal.

4. The method of claim 1 wherein the step of transforming is based on an acoustic wave transfer function of the structure between said sensor and at least one location in the structure remote from the sensor, the acoustic wave transfer function determined from a method including steps comprising:
(i) at a selected location in the structure, inducing acoustic waves in the structure of known parameters; and
(ii) calculating a structure transfer function based on the signal produced by an acoustic sensor in response to the induced acoustic waves.

5. A method of monitoring acoustic wave propagation in a structure comprising:
(i) coupling at least two acoustic sensors to a structure, one sensor at a first sensor location and a second sensor at a location remote from said first sensor location;
(ii) determining an acoustic wave transfer function of the structure between each said sensor location and at least one location in the structure remote from said sensor location;
(iii) monitoring signals from each acoustic sensor at an acquisition system for a trigger event;
(iv) upon detection of a trigger event, calculating the location of an acoustic source corresponding to the trigger event;
(v) transforming the signal from each acoustic sensor using a wave transfer function of the structure based on the calculated location of the acoustic source;
(vi) testing selected parameters of the transformed signal against corresponding parameters of an event of interest; and
(vii) logging the signals from each acoustic sensor for each event of interest.

6. The method of claim 5 wherein the detection of a trigger event occurs when the amplitude of a signal from an acoustic sensor exceeds a threshold value.

7. The method of claim 6 wherein the selected parameters include the amplitude, spectral content or duration of the transformed signal.

8. The method of claim 6 wherein determining the acoustic wave transfer function of the structure between said sensor location and at least one location in the structure remote from each said first and second sensor locations comprises:
(i) at a selected location in the structure, inducing acoustic waves in the structure of known parameters; and
(ii) calculating a structure transfer function based on the signal produced by an acoustic sensor in response to the induced acoustic waves.

9. A method of monitoring acoustic wave propagation in a structure comprising:
(i) coupling at least two acoustic sensors to a structure, one at a first sensor location and another at a second sensor location remote from said first sensor location;
(ii) monitoring signals from each acoustic sensor for a trigger event at an acquisition system;
(iii) upon detection of a trigger event, calculating the location of an acoustic source corresponding to the trigger event;
(iv) transforming parameters of an event of interest using the calculated location of the acoustic source;
(v) testing selected parameters of the monitored signal against corresponding transformed parameters of an event of interest; and
(vi) logging the signals from each acoustic sensor for each event of interest.

10. The method of claim 9 wherein the detection of a trigger event occurs when the amplitude of a signal from an acoustic sensor exceeds a threshold value.

11. The method of claim 9 wherein the selected parameters include the amplitude, spectral content or duration of the monitored signal.

12. The method of claim 9 wherein the step of transforming is based on an acoustic wave transfer function of the structure between said sensor and at least one location in the structure remote from the sensor, the acoustic wave transfer function determined from a method including steps comprising:
(i) at a selected location in the structure, inducing acoustic waves in the structure of known parameters; and
(ii) calculating a structure transfer function based on the signal produced by an acoustic sensor in response to the induced acoustic waves.

13. A method of monitoring acoustic wave propagation in a structure comprising:
(i) coupling at least two acoustic sensors to a structure, one sensor at a first sensor location and another sensor at a location remote from said first sensor location respectively;
(ii) monitoring signals from at least one acoustic sensor at an acquisition system for a trigger event;
(iii) upon detection of a trigger event, logging the signals from each acoustic sensor;
(iv) processing logged signals to calculate the location of an acoustic source corresponding to the trigger event; transforming the logged signal from each acoustic sensor using the calculated location and testing selected parameters of the transformed signal against corresponding parameters of an event of interest.

14. The method of claim 12 wherein the detection of a trigger event occurs when the amplitude of a signal from an acoustic sensor exceeds a threshold value.

15. The method of claim 12 wherein the selected parameters include the amplitude, spectral content or duration of the transformed signal.

16. The method of claim 12 wherein the step of transforming is based on an acoustic wave transfer function of the structure between said first and second sensor locations and at least one location in the structure remote from each said first and second sensor locations, the acoustic wave transfer function determined from a method including steps comprising:
(i) at a selected location in the structure, inducing acoustic waves in the structure of known parameters; and
(ii) calculating a structure transfer function based on the signal produced by an acoustic sensor in response to the induced acoustic waves.

17. A method of monitoring acoustic wave propagation in a structure comprising:
(i) coupling at least two acoustic sensors to a structure, one sensor at a first sensor location and another sensor at a location remote from said first sensor location;
(ii) determining an acoustic wave transfer function of the structure between each said sensor location and at least one location in the structure remote from each said sensor location;
(iii) monitoring signals from each acoustic sensor at an acquisition system for a trigger event;
(iv) upon detection of a trigger event, logging the signals from each acoustic sensor;
(v) processing the logged signals using the steps of calculating the location of an acoustic source corresponding to the trigger event; transforming the signal from each acoustic sensor using a wave transfer function of the structure based on the calculated location of the acoustic source; and testing selected parameters of the transformed signal against corresponding parameters of an event of interest.

18. The method of claim 17 wherein the detection of a trigger event occurs when the amplitude of a signal from an acoustic sensor exceeds a threshold value.

19. The method of claim 18 wherein the selected parameters include the amplitude, spectral content or duration of the transformed signal.

20. The method of claim 18 wherein determining the acoustic wave transfer function of the structure between said sensor location and at least one location in the structure remote from each sensor locations comprises:
(i) at a selected location in the structure, inducing acoustic waves in the structure of known parameters; and
(ii) calculating a structure transfer function based on the signal produced by an acoustic sensor in response to the induced acoustic waves.

21. A method of monitoring acoustic wave propagation in a structure comprising:
(i) coupling at least two acoustic sensors to a structure, one at a first sensor location and another at a second sensor location remote from said first sensor location;
(ii) monitoring signals from each acoustic sensor for a trigger event at an acquisition system;
(iii) upon detection of a trigger event, logging the signals from each acoustic sensor for each event of interest; and
(iv) processing the logged signals including the steps of calculating the location of an acoustic source corresponding to the trigger event; transforming parameters of an event of interest using the calculated location of the acoustic source; and testing selected parameters of the monitored signal against corresponding transformed parameters of an event of interest.

22. The method of claim 21 wherein the detection of a trigger event occurs when the amplitude of a signal from an acoustic sensor exceeds a threshold value.

23. The method of claim 21 wherein the selected parameters include the amplitude, spectral content or duration of the monitored signal.

24. The method of claim 21 wherein the step of transforming is based on an acoustic wave transfer function of the structure between said sensor and at least one location in the structure remote from the sensor, the acoustic wave transfer function determined from a method including steps comprising:
(i) at a selected location in the structure, inducing acoustic waves in the structure of known parameters; and
(ii) calculating a structure transfer function based on the signal produced by an acoustic sensor in response to the induced acoustic waves.
